(19) United States
(12) Patent Application Publication
(10) Pub. No.: US 2016/0212492 A1
(43) Pub. Date: Jul. 21, 2016

(54) SYSTEMS AND METHODS FOR AUTOMATICALLY MODIFYING FUNCTIONALITY OF AN ACTUATOR

(71) Applicant: Rovi Guides, Inc., Santa Clara, CA (US)

(72) Inventor: Soho Mori, Tokyo (JP)

(21) Appl. No.: 14/602,000

(22) Filed: Jan. 21, 2015

(51) Int. Cl. H04N 21/482; H04N 21/431; H04N 21/422; H04N 21/25; H04N 21/466; H04N 21/45; H04N 21/84; H04N 21/41

(52) U.S. Cl. CPC H04N 21/4826; H04N 21/84; H04N 21/4312; H04N 21/4122; H04N 21/251; H04N 21/4668; H04N 21/4532; H04N 21/42204

(57) ABSTRACT

Systems and methods are described herein for enabling a viewer to quickly toggle through related media assets without having to remove their attention from any given media assets. For example, if a user is watching a soccer game but wants to switch between two or more other soccer games the user is interested in, the user's remote control device may be automatically reprogrammed to allow the user to switch between soccer games at the touch of a numbered button on the remote control that corresponds to a different soccer game, rather than having to open up a program guide to learn what channel the different soccer game is playing on. This may help the user navigate to the different soccer game in time without costing the user any time in transition.

### BACKGROUND OF THE INVENTION

Every moment lost when attempting to view a sports game could cost a viewer the chance to view an important or meaningful play. Often, viewing time is lost when a user attempts to navigate between two or more concurrent sporting matches. For example, time may be lost as a user navigates an Electronic Programming Guide (EPG) in order to locate what channel a sporting match is played on, and this lost time may cost the viewer the ability to view a big play or a scored goal.

### SUMMARY

Systems and methods are described herein for enabling a viewer to quickly toggle through related media assets without having to remove their attention from any given media assets. For example, if a user is watching a soccer game but wants to switch between two or more other soccer games the user is interested in, the user's remote control device may be automatically reprogrammed to allow the user to switch between soccer games at the touch of a numbered button on the remote control that corresponds to a different soccer game, rather than having to open up a program guide to learn what channel the different soccer game is playing on. This may help the user navigate to the different soccer game without costing the user any time in transition.

In some aspects, control circuitry may receive a selection of a media asset. For example, control circuitry may receive a user selection of the soccer game USA v. Costa Rica. The selected soccer game may be, for example, broadcast over a cable, television, or radio network, or may be accessible via an Over-The-Top (OTT) or on-demand application. Control circuitry may then determine a category that the media asset corresponds to. Following from the example above, control circuitry may determine that “USA v. Costa Rica” corresponds to the sport of soccer, and may, therefore, determine that “USA v. Costa Rica” corresponds to the category of “soccer.” This determination may be made based on metadata associated with “USA v. Costa Rica” (e.g., as learned from EPG information stored in a set top box, or as learned from metadata packaged in a Vertical Blanking Interval (VBI) signal, or as described in one or more communications received via an OTT application).

Control circuitry may then determine a plurality of media assets that (1) correspond to the category, and (2) are presently available. For example, if a number of soccer games are presently airing, control circuitry may identify each soccer game that is presently airing and accessible to the user. When the plurality of media assets are determined, control circuitry may generate a correspondence between a plurality of actuators of a user equipment device and the plurality of media assets. For example, the user equipment device may be a remote control device with buttons 1-9 that are typically used to enter a channel number to navigate to. Control circuitry may generate a correspondence between each of the buttons 1-9 and each of nine identified soccer games, such that, when the button “3” is pressed, a soccer game corresponding to that button is navigated to. In this manner, a user who is interested in several soccer games may be enabled to navigate between them easily and seamlessly even when the user does not know exactly where the soccer game is accessible from.

In some embodiments, control circuitry may generate for display a mapping that describes the correspondence. For example, control circuitry may cause a menu to be displayed showing which soccer game each reprogrammed button on a remote control will lead a user to, if a button is pressed. The menu may alternatively or additionally be displayed persistently either adjacent to a display of the soccer game, or in an overlay on top of the soccer game. Control circuitry may toggle the menu on or off, or may move the menu to be displayed in an overlay, in a particular portion of a screen, or in full screen mode, in response to a user command. In some embodiments, the menu may be displayed on a device different from the device on which the media asset is displayed. For example, control circuitry may cause the media asset (e.g., USA v. Costa Rica) to be displayed on a television device, and may cause the menu (e.g., mapping of buttons 1-9 to other soccer games) to be displayed on a different device, such as a smart phone or tablet.

In some embodiments, control circuitry may generate the correspondence between actuators of the user equipment device and the media assets of the plurality of media assets based on a ranking of the plurality of media assets. For example, following the soccer example above, control circuitry may rank soccer games based on a league ranking of each soccer team featured in each available soccer game. As another example, control circuitry may rank the media assets based on a user profile. For example, if a user viewing history indicates that a user often watches soccer games featuring Germany and Ghana, but rarely watches soccer games featuring Japan or Switzerland, control circuitry may rank available soccer games featuring Germany and Ghana ahead of those featuring Japan or Switzerland. Once a ranking is determined, control circuitry may correspond each actuator to a media asset in order of ranking. For example, if the buttons of a remote control 1-9 are to be reassigned to correspond to media assets such as soccer games, control circuitry may cause the reassignment to reflect the ranking, where button 1 corresponds to a highest ranking, button 2 corresponds to a next highest ranking, and so on.

In some embodiments, each actuator of the plurality of actuators may be assigned a usual function. For example, in the remote control example discussed above, remote control buttons 1-9 may be assigned a usual function of explaining to control circuitry what channel should be tuned to. Control circuitry may, however, in response to generating the correspondence between the actuators and the plurality of media assets, assign each actuator of the plurality of actuators a function for a period of time. For example, the 1-9 buttons on a remote control may be assigned the function of tuning to a particular media asset, rather than tuning to a channel indicated by the number pressed, when the remote control button is actuated. Control circuitry may then, following the period of time, cause the usual function of the actuators to be reassigned. Reassignment of the actuators to their usual function may occur, for example, after a predetermined period of time, after a selected media asset ends, or in response to a user request to reassign the usual function of the actuators.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5 shows an illustrative embodiment of a user equipment device on which a selected media asset is displayed, in accordance with some embodiments of the disclosure; and

FIG. 6 is a flowchart of illustrative steps involved in determining which actuators of a user equipment device to assign to which media asset, in accordance with some embodiments of the disclosure.

### DETAILED DESCRIPTION

Systems and methods are described herein for enabling a viewer to quickly toggle through related media assets without having to remove their attention from any given media assets. For example, if a user is watching a soccer game but wants to switch between two or more other soccer games the user is interested in, the user's remote control device may be automatically reprogrammed to allow the user to switch between soccer games at the touch of a numbered button on the remote control that corresponds to a different soccer game, rather than having to open up a program guide to learn which channel the different soccer game is playing. This may help the user navigate to the different soccer game in time without costing the user any time in transition.

In some aspects, control circuitry may receive a selection of a media asset. For example, control circuitry may receive a user selection of the soccer game USA v. Costa Rica. The selected soccer game may be, for example, broadcast over a cable, television, or radio network, or may be accessible via an Over-The-Top (OTT) or on-demand application. Control circuitry may then determine a category that the media asset corresponds to. Following from the example above, control circuitry may determine that “USA v. Costa Rica” corresponds to the sport of soccer, and may therefore determine that “USA v. Costa Rica” corresponds to the category of “soccer.” This determination may be made based on metadata associated with “USA v. Costa Rica” (e.g., as learned from EPG information stored in a set top box, or as learned from metadata packaged in a Vertical Blanking Interval (VBI) signal, or as described in one or more communications received via an OTT application).

Control circuitry may then determine a plurality of media assets that (1) correspond to the category, and (2) are presently available. For example, if a number of soccer games are presently airing, control circuitry may identify each soccer game that is presently airing and accessible to the user. When the plurality of media assets are determined, control circuitry may generate a correspondence between a plurality of actuators of a user equipment device and the plurality of media assets. For example, the user equipment device may be a remote control device with buttons 1-9 that are typically used to enter a channel number to navigate to. Control circuitry may generate a correspondence between each of the buttons 1-9 and each of nine identified soccer games, such that when the button “3” is pressed, a soccer game corresponding to that button is navigated to. In this manner, a user who is interested in several soccer games may be enabled to navigate between them easily and seamlessly even when the user does not know exactly where the soccer game is accessible from.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

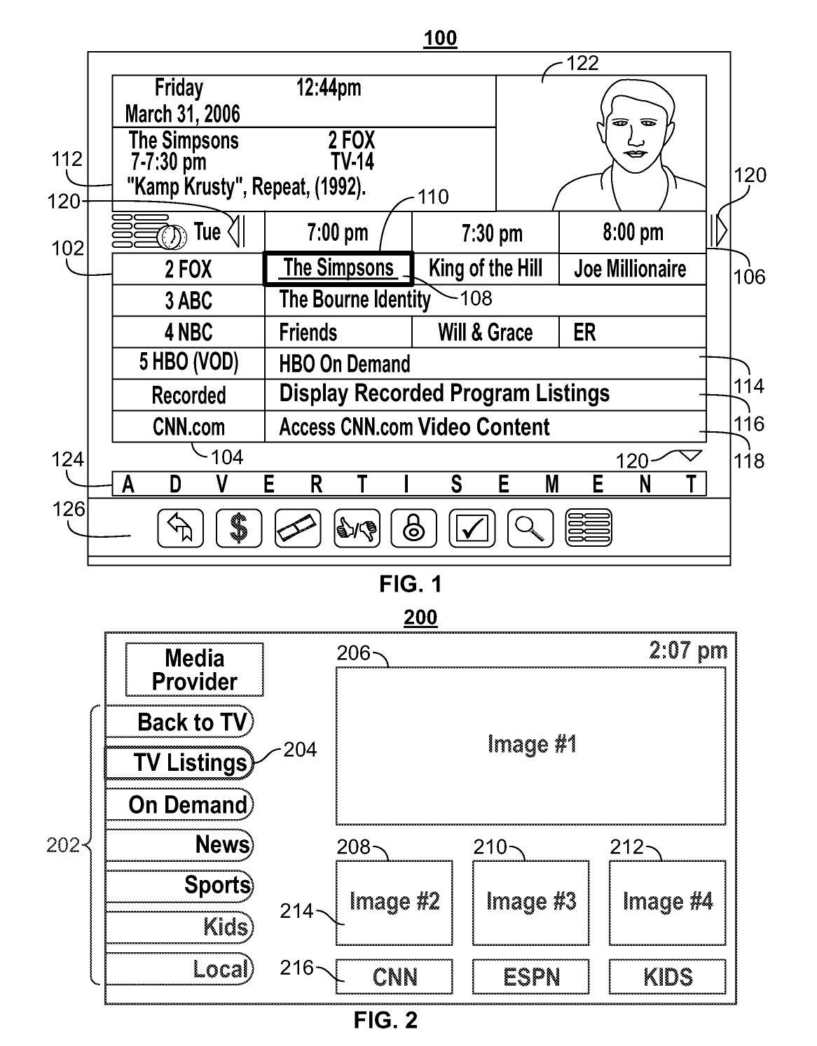

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

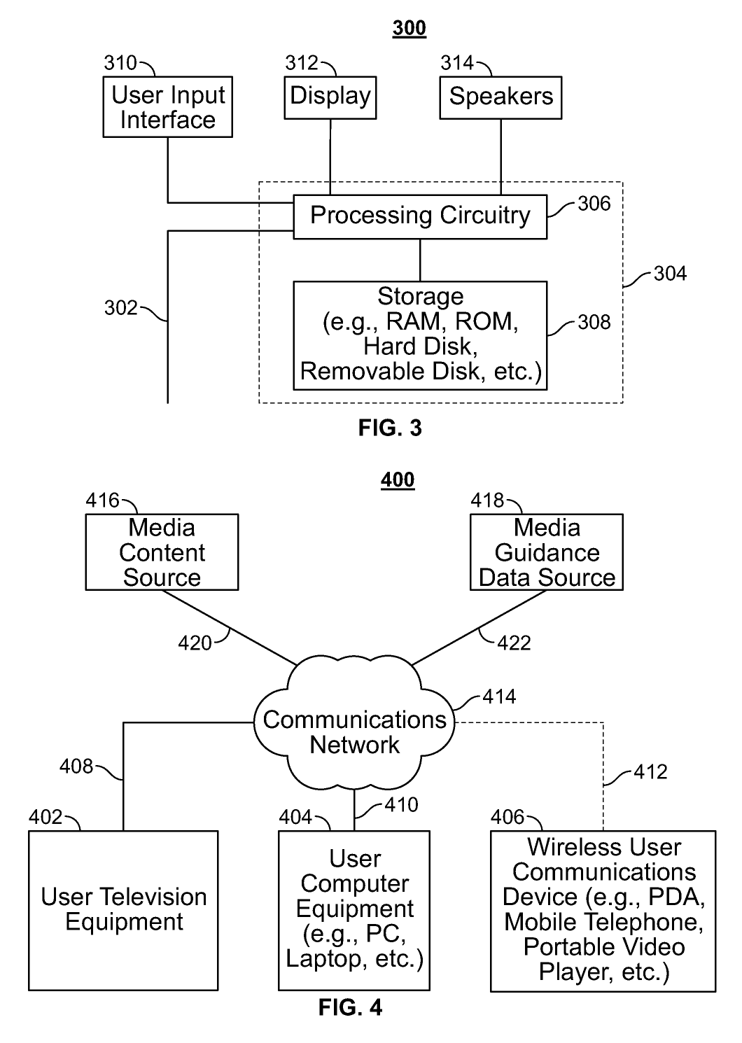

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

The term “category” wherever used in this disclosure is defined to mean a context corresponding to a media asset. For example, a category may be a type, genre, age group, or rating of a media asset, or the like. A category may be broad (e.g., “sports”) or narrow (e.g., “soccer”).

The term “actuator” wherever used in this disclosure is defined to mean an interface which, when interacted with by a user, causes a function to be performed. The interface may be hardware-based (e.g., a button on a remote controller that causes a function to be performed when depressed), software-based (e.g., a depiction on a graphical user interface that, when interacted with by a user (e.g., tapped, clicked, highlighted, or the like) causes a function to be performed (e.g., a virtual remote controller or interactive guidance application), or a combination of both.

In some embodiments, control circuitry 304 may receive a user selection of a soccer game. Control circuitry 304 may automatically reprogram a user's remote control device or media guidance application such that, if the user wants to switch between two or more other soccer games the user is interested in, where control circuitry 304 detects a selection of a numbered button on the remote control that corresponds to a different soccer game, control circuitry 304 may cause that different soccer game to be tuned to. Thus, control circuitry 304 enables a user to skip the laborious step of having to open a guidance application or menu to learn what channel the different soccer game is playing on. This may help the user navigate to the different soccer game in time without costing the user any time in transition.

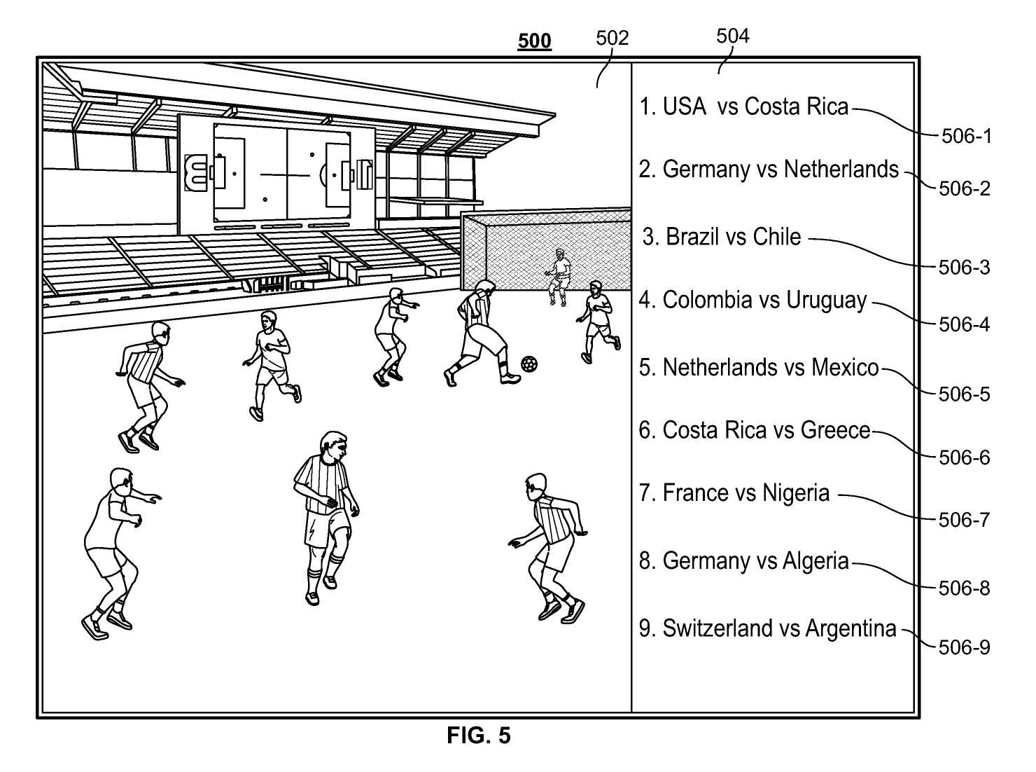

FIG. 5 shows an illustrative embodiment of a user equipment device on which a selected media asset is displayed, in accordance with some embodiments of the disclosure. FIG. 5 shows user equipment device 500 with an illustrative display including a displayed media asset 502 and an optional display 504 including media asset identifiers 506. In some embodiments, control circuitry 304 receives a selection of media asset 502 (e.g., by way of user interaction through user input interface 310). Control circuitry 304 may receive a selection by detecting any known user interaction, such as a user identifying a channel to tune to (e.g., via a “Channel Up” button or by navigating to a next channel), a user identifying a media asset for viewing (e.g., a selection of a media asset that is broadcast on a particular channel or is available on-demand and/or over the Internet or through an OTT provider), and the like. In the example illustrated in FIG. 5, selected media asset 502 is a soccer match of the United States of America (USA) versus Costa Rica.

In some embodiments, control circuitry 304 may determine a category that selected media asset 502 corresponds to. For example, control circuitry 304 may determine that media asset 502, which is a soccer match of USA v. Costa Rica, is of the category of “sports” or “soccer.” Other categories may be determined as well; for example, if the USA v. Costa Rica match is part of a league or championship, such as the World Cup, then control circuitry 304 may determine a category to which media asset 502 corresponds to be the World Cup.

In some embodiments, control circuitry 304 may identify a plurality of media assets that both correspond to the category and are presently available. For example, control circuitry 304 may determine the category to which media asset 502 corresponds to be “World Cup.” Control circuitry 304 may then determine that other soccer matches from the World Cup are presently available. For example, control circuitry 304 may determine that Germany v. Netherlands and Switzerland v. Argentina are also matches from the world cup that are presently available. As another example, control circuitry 304 may determine that the category is “sports,” in which case control circuitry 304 may identify all other sports matches that are currently available.

In some embodiments, control circuitry 304 may generate a correspondence between a plurality of actuators of a user equipment device and the plurality of media assets. For example, if the user equipment device is a remote control device, control circuitry 304 may correspond various buttons of the remote control device to each identified media asset of the plurality of media assets. In one example, control circuitry 304 may determine the user equipment device is a remote controller device with buttons 1-9, and may map each identified media asset to one of the buttons, such that, when the button is pressed, the corresponding media asset is generated for display. As an example, control circuitry 304 may determine the category to be “World Cup” and may identify soccer matches of “USA v. Costa Rica” (e.g., media asset 506-1), “Germany v. Netherlands” (e.g., media asset 506-2), and “Switzerland v. Argentina” (e.g., media asset 506-3) as currently playing. Control circuitry 304 may then map each of the three identified media assets to actuators of the user equipment device. For example, control circuitry 304 may determine that buttons 1, 2, and 3 should respectively be mapped to media assets of the plurality of media assets.

In some embodiments, control circuitry 304 may determine the manner in which actuators are to correspond to media assets of the plurality of media assets by ranking each media asset of the plurality of media assets against one another. For example, if buttons 1-9 on a remote are to be assigned to media assets of the plurality of media assets, such that when a button is pressed, a corresponding media asset is generated for display, control circuitry 304 may rank the media assets to determine a highest ranked media asset to be assigned to button “1,” a next highest ranked media asset to be assigned to button “2,” and so on.

In some embodiments, control circuitry 304 may rank media assets based on a user profile. For example, control circuitry 304 may first access a user profile by querying a database. The database may be remote (e.g., media guidance data source 418) or local (e.g., storage 306). Control circuitry 304 may then determine a preference of a user based on the user profile. For example, if a user is a citizen of the USA, control circuitry 304 may determine that the user prefers to watch soccer matches including the USA. Control circuitry 304 may then rank the plurality of media assets in the order of how closely each media asset of the plurality of media assets matches the determined preference. As an example, control circuitry 304 may determine that media asset 506-1 (e.g., USA v. Costa Rica) stars the USA soccer team, and may determine that media asset 506-2 (e.g., Germany v. Netherlands) does not star the USA soccer team. Accordingly, control circuitry 304 may rank media asset 506-1 as higher than media asset 506-2, and may correspond media asset 506-1 to a more preferable button than media asset 506-2 (e.g., by mapping the button “1” on a remote controller to media asset 506-1 and mapping the button “2” on a remote controller to media asset 506-2).

In some embodiments, control circuitry 304 may determine that the category of selected media asset 502 is a sport (e.g., soccer), and may determine a team associated with each media asset of the plurality of media assets. For example, control circuitry may determine that the teams USA, Costa Rica, Germany, Netherlands, Argentina, and Switzerland are all playing in media assets 506, which are presently available. Control circuitry 304 may then determine a relative ranking of each of the teams starring in media assets 506, as compared to each other team starring in media assets 506. In some embodiments, control circuitry 304 may rank each media asset based on the associated team's determined relative ranking. For example, if Germany presently is ranked in first place in the World Cup, and Switzerland is ranked 4th place in the World Cup, control circuitry 304 may assign Germany a higher value actuator (e.g., the button “2” on a remote control) and may assign Switzerland a lower value actuator (e.g., the button “3” on a remote control).

In some embodiments, control circuitry 304 may generate for display a mapping that describes a determined correspondence. As an example, control circuitry 304 may cause user equipment 500 to display optional display 504 that indicates correspondences 506. Correspondences 506 may indicate a media asset identifier as well as an identifier of which actuator is presently mapped to a respective media asset 506. Optional display 504 is depicted as a display that takes up a portion of display 312 of user equipment 500, but may be displayed in any manner, such as in an overlay over media asset 502, or on a second device different from user equipment 500 (e.g., if a user is viewing media asset 502 on user television equipment 416, control circuitry 304 may cause optional display 504 to be generated for display at different user equipment 418 (e.g., a tablet device).

In some embodiments, control circuitry 304 may toggle optional display 504 on or off in response to user input. For example, control circuitry 304 may receive a user request (e.g., by way of a remote control device or a user equipment device such as user equipment 416) to toggle on optional display 504. Control circuitry may responsively cause optional display 504 to be generated for display in any manner described above or below.

In some embodiments, such as the remote control embodiment, control circuitry 304 may determine that default functions are typically assigned to each actuator of the plurality of actuators. For example, control circuitry 304 may determine that when the button “9” on a remote controller is activated, control circuitry 304 is to react by causing a television to tune to channel 9. Control circuitry 304 may, in response to generating the correspondences discussed above, cause a new function to be assigned to each actuator of the plurality of actuators for a period of time. For example, the button “9” may have its usual functionality replaced, for a period of time, by a function to cause media asset 506-3 “Switzerland v. Argentina” to be generated for display. In these instances, control circuitry 304 may restore the usual function of each actuator that had its usual function replaced to its usual functionality after the period of time lapses.

In some embodiments, the period of time for which control circuitry 304 is to replace an actuator's functionality with the determined correspondence is a predefined period of time. The predefined period may be defined by a user (e.g., by a user specifically requesting how long a mapping should last), be it when the mapping originally occurs, or in setting global or default settings. The predefined period may be defined automatically (e.g., by factory settings, or by control circuitry 304 determining a predefined period on any number of factors, such as determined user preferences, a length of a media asset, or the like). In some embodiments, control circuitry 304 may determine the period of time to be an amount of time until selected media asset 502 ends, be it by selected media asset 502 being fully played back, or by control circuitry 304 determining that a user has navigated away from selected media asset 502. In some embodiments, control circuitry 304 may determine the period of time to be a period of time beginning when control circuitry 304 replaces the usual functionality of an actuator with the new functionality of the actuator, and ending upon a user request to reassign the usual function to each actuator of the plurality of actuators. In some embodiments, control circuitry 304 may allow a user to toggle between the usual functionality of the plurality of actuators and the new functionality of the plurality of actuators. For example, control circuitry 304 may enable the new functionality of actuators in response to a user request to do so, and may disable the new functionality of actuators in response to a user request to do so.

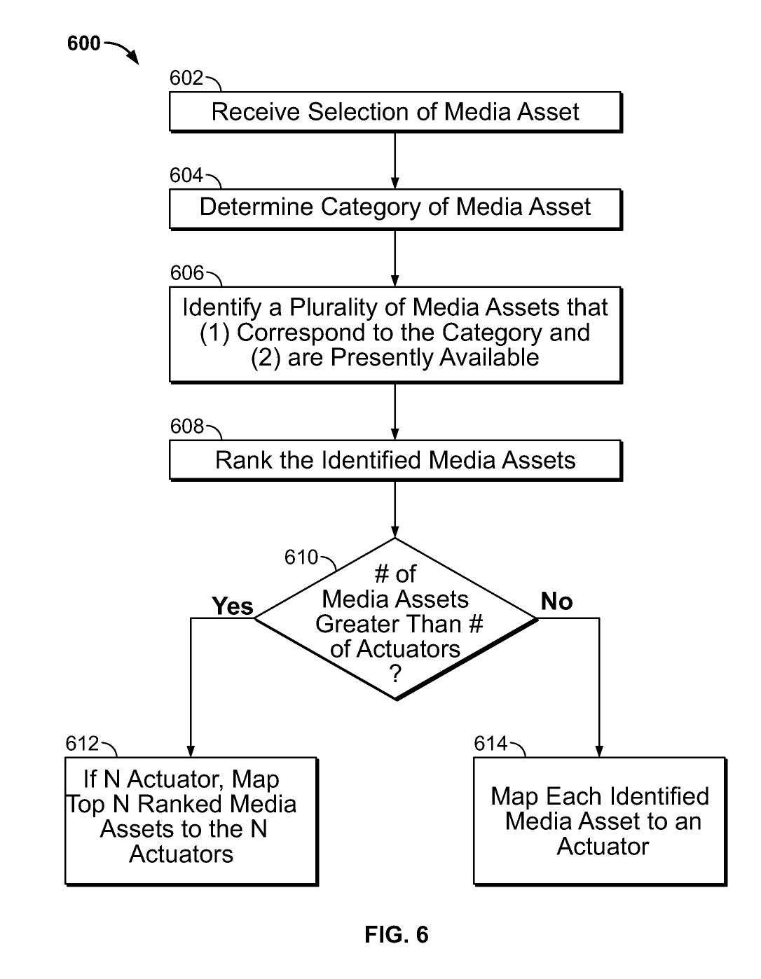

FIG. 6 is a flowchart of illustrative steps involved in determining which actuators of a user equipment device to assign to which media asset, in accordance with some embodiments of the disclosure. It should be noted that process 600 or any step thereof could be performed on, or provided by, any of the devices shown in FIGS. 3-5. For example, process 600 may be executed by control circuitry 304 (FIG. 3) as instructed by control circuitry implemented on user equipment 402, 404, and/or 406 (FIG. 4) in order to determine whether to use a user-selected or automatically selected avatar to communicate information. In addition, one or more steps of process 600 may be incorporated into or combined with one or more steps of any other process or embodiment.

Process 600 begins at 602, where control circuitry (e.g., control circuitry 304) may receive a selection of a media asset (e.g., media asset 502) (e.g., by way of user interaction through user input interface 310). Control circuitry 304 may receive a selection by detecting any known user interaction, such as a user identifying a channel to tune to (e.g., via a “Channel Up” button or by navigating to a next channel), a user identifying a media asset for viewing (e.g., a selection of a media asset that is broadcast on a particular channel or is available on-demand and/or over the Internet or through an OTT provider), and the like.

Process 600 continues to 604, where control circuitry 304 may determine a category that selected media asset 502 corresponds to. For example, control circuitry 304 may determine that media asset 502, which is a soccer match of the USA versus Costa Rica, is of the category of “sports” or “soccer.” Other categories may be determined as well; for example, if the USA v. Costa Rica match is part of a league or championship, such as the World Cup, then control circuitry 304 may determine a category to which media asset 502 corresponds to be the World Cup.

Process 600 may then proceed to 606, where control circuitry 304 may identify a plurality of media assets that both correspond to the category and are presently available. For example, control circuitry 304 may determine the category that media asset 502 corresponds to be “World Cup.” Control circuitry 304 may then determine that other soccer matches from the World Cup are presently available. For example, control circuitry 304 may determine that Germany v. Netherlands and Switzerland v. Argentina are also matches from the world cup that are presently available. As another example, control circuitry 304 may determine that the category is “sports,” in which case control circuitry 304 may identify all other sports matches that are currently available.

Process 600 may optionally proceed to 608, where control circuitry 304 may rank the identified media assets. Process 600 may alternatively proceed to 614, where the identified media assets are mapped to actuators. At 608, control circuitry 304 may rank the media assets to determine a highest ranked media asset. In some embodiments, control circuitry 304 may rank media assets based on a user profile. For example, control circuitry 304 may first access a user profile by querying a database. The database may be remote (e.g., media guidance data source 418) or local (e.g., storage 306). Control circuitry 304 may then determine a preference of a user based on the user profile. For example, if a user is a citizen of the USA, control circuitry 304 may determine that the user prefers to watch soccer matches including the USA. Control circuitry 304 may then rank the plurality of media assets in order of how closely each media asset of the plurality of media assets matches the determined preference. As an example, control circuitry 304 may determine that media asset 506-1 (e.g., USA v. Costa Rica) stars the USA soccer team, and may determine that media asset 506-2 (e.g., Germany v. Netherlands) does not star the USA soccer team. Accordingly, control circuitry 304 may rank media asset 506-1 as higher than media asset 506-2, and may correspond media asset 506-1 to a more preferable button than media asset 506-2.

In some embodiments, control circuitry 304 may determine that the category of selected media asset 502 is a sport (e.g., soccer), and may determine a team associated with each media asset of the plurality of media assets. For example, control circuitry may determine that the teams USA, Costa Rica, Germany, Netherlands, Argentina, and Switzerland are all playing in media assets 506, which are presently available. Control circuitry 304 may then determine a relative ranking of each of the teams starring in media assets 506, as compared to each other team starring in media assets 506. In some embodiments, control circuitry 304 may rank each media asset based on the associated team's determined relative ranking. For example, if Germany presently is ranked in first place in the World Cup, and Switzerland is ranked 4th place in the World Cup, control circuitry 304 may assign Germany a higher rank, and may assign Switzerland a lower rank.

Process 600 may proceed to 610, where it is determined whether the number of identified media assets is greater than the number of actuators (e.g., of a remote control device). For example, a remote control device may have buttons 1-9, and control circuitry 304 may determine whether there are 10 or more identified media assets. If control circuitry 304 determines there are 10 or more identified media assets, control circuitry 304 would determine that the number of identified media assets is greater than the number of buttons on the remote. If control circuitry 304 determines that there are 9 or fewer identified media assets, control circuitry 304 would determine that the number of identified media assets is not greater than the number of buttons on the remote.

If control circuitry 304 determines that the number of identified media assets is greater than the number of actuators, control circuitry 304 may cause process 600 to proceed to 612. If, alternatively, control circuitry 304 determines that the number of identified media assets is not greater than the number of actuators, control circuitry 304 may cause process 600 to proceed to 614.

At 612, because there are not enough actuators to map each identified media asset to an actuator, control circuitry 304 may map the top N ranked media assets to the N actuators. For example, if the user equipment device is a remote control device with buttons 1-9, the top 9 ranked media assets may be mapped to the buttons. These mappings may be done based on rank, where button 1 is mapped to the highest ranked media asset, button 2 is mapped to the next highest ranked media asset, and so on.

At 614, control circuitry 304 may map each identified media asset to an actuator. For example, if there are five identified media assets, and the user equipment device is a remote controller with buttons 1-9, five of buttons 1-9 may be mapped to the five identified media assets. In some embodiments, the mapping may be based on rank, where button 1 is mapped to the highest ranked media asset, button 2 is mapped to the next highest ranked media asset, and so on.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 6.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, determination of media asset ranking may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the media asset correspondences as described herein may be stored in, and retrieved from, storage 308 of FIG. 3, or media guidance data source 418 of FIG. 4. Furthermore, processing circuitry, or a computer program, may update settings associated with a user, such as user profile preferences, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method comprising:
receiving a selection of a media asset;
determining a category that the media asset corresponds to;
identifying a plurality of media assets that (1) correspond to the category, and (2) are presently available; and
generating a correspondence between a plurality of actuators of a user equipment device and the plurality of media assets.

2. The method of claim 1, further comprising:
generating for display a mapping that describes the correspondence.

3. The method of claim 2, further comprising:
toggling the display of the mapping on or off in response to user input.

4. The method of claim 2, wherein the selected media asset is displayed on a first device, and wherein the mapping is displayed on a second device different from the first device.

5. The method of claim 1, wherein generating the correspondence comprises:
ranking the plurality of media assets, wherein a first media asset of the plurality of media assets is ranked first, and wherein a second media asset of the plurality of media assets is ranked second;
corresponding a first actuator of the plurality of actuators to the first media asset; and
corresponding a second actuator of the plurality of actuators to the second media asset.

6. The method of claim 5, wherein the ranking further comprises:
accessing a user profile;
determining a preference of the user based on the user profile; and
ranking the plurality of media assets in order of how closely each media asset of the plurality of media assets matches the determined preference.

7. The method of claim 5, wherein the category is a sport, and wherein the ranking further comprises:
determining a team associated with each media asset of the plurality of media assets;
determining a relative ranking of the team as compared to each other team associated with each other media asset of the plurality of media assets; and
ranking each media asset based on the determined relative ranking.

8. The method of claim 1, wherein each actuator of the plurality of actuators is assigned a usual function, wherein in response to generating the correspondence, each actuator of the plurality of actuators is assigned a new function for a period of time, and wherein the method further comprises reassigning the usual function to each actuator of the plurality of actuators at the end of the period of time.

9. The method of claim 8, wherein the period of time comprises at least one of: a predefined period of time, the selected media asset ending, and a period of time beginning when the new function is assigned and ending upon a user request to reassign the usual function to each actuator of the plurality of actuators.

10. The method of claim 1, wherein:
the plurality of media assets comprise a plurality of broadcast sports programs,
the user equipment device is a remote control device,
each actuator of the plurality of actuators is a numbered button of the remote control device, and
the correspondence comprises a mapping of a broadcast sports program of the plurality of broadcast sports programs to one of the numbered buttons of the remote control device.

11. A system comprising:
user input circuitry; and
control circuitry configured to:
receive, using the user input circuitry, a selection of a media asset;
determine a category that the media asset corresponds to;
identify a plurality of media assets that (1) correspond to the category, and (2) are presently available; and
generate a correspondence between a plurality of actuators of a user equipment device and the plurality of media assets.

12. The system of claim 11, wherein the control circuitry is further configured to:
generate for display a mapping that describes the correspondence.

13. The system of claim 12, wherein the control circuitry is further configured to:
toggle the display of the mapping on or off in response to user input.

14. The system of claim 12, wherein the selected media asset is displayed on a first device, and wherein the mapping is displayed on a second device different from the first device.

15. The system of claim 11, wherein the control circuitry is further configured, when generating the correspondence, to:
rank the plurality of media assets, wherein a first media asset of the plurality of media assets is ranked first, and wherein a second media asset of the plurality of media assets is ranked second;
correspond a first actuator of the plurality of actuators to the first media asset; and
correspond a second actuator of the plurality of actuators to the second media asset.

16. The system of claim 15, wherein the control circuitry is further configured, when ranking the plurality of media assets, to:
access a user profile;
determine a preference of the user based on the user profile; and
rank the plurality of media assets in order of how closely each media asset of the plurality of media assets matches the determined preference.

17. The system of claim 15, wherein the category is a sport, and wherein the control circuitry is further configured, when ranking the plurality of media assets, to:
determine a team associated with each media asset of the plurality of media assets;
determine a relative ranking of the team as compared to each other team associated with each other media asset of the plurality of media assets; and
rank each media asset based on the determined relative ranking.

18. The system of claim 11, wherein each actuator of the plurality of actuators is assigned a usual function, wherein in response to generating the correspondence, each actuator of the plurality of actuators is assigned a new function for a period of time, and wherein the control circuitry is further configured to reassign the usual function to each actuator of the plurality of actuators at the end of the period of time.

19. The system of claim 18, wherein the period of time comprises at least one of: a predefined period of time, the selected media asset ending, and a period of time beginning when the new function is assigned and ending upon a user request to reassign the usual function to each actuator of the plurality of actuators.

20. The system of claim 11, wherein:
the plurality of media assets comprise a plurality of broadcast sports programs,
the user equipment device is a remote control device,
each actuator of the plurality of actuators is a numbered button of the remote control device, and
the correspondence comprises a mapping of a broadcast sports program of the plurality of broadcast sports programs to one of the numbered buttons of the remote control device.

21-50. (canceled)
